(19) United States
(12) Patent Application Publication
(10) Pub. No.: US 2020/0130680 A1
(43) Pub. Date: Apr. 30, 2020

(54) PRE-ACTIVE ADJUSTMENT SAFETY CONTROL METHOD AND APPARATUS

(71) Applicants: HYUNDAI MOTOR COMPANY, Seoul (KR); KIA MOTORS CORPORATION, Seoul (KR)

(72) Inventors: Young Kuen Cho, Suwon-si (KR); Hyung Joo Kim, Busan (KR); Sung Rae Kim, Seoul (KR); Dong Ho Park, Gunpo-si (KR); Gwi Young Park, Seongnam-si (KR); Dong Woo Jeong, Hwaseong-si (KR); In Ju Lee, Seoul (KR)

(73) Assignees: HYUNDAI MOTOR COMPANY, Seoul (KR); KIA MOTORS CORPORATION, Seoul (KR)

(21) Appl. No.: 16/555,825

(22) Filed: Aug. 29, 2019

(30) Foreign Application Priority Data
Oct. 26, 2018 (KR) 10-2018-0128775

(51) Int. Cl. B60W 30/09; B60W 30/095; B60N 2/02

(52) U.S. Cl. CPC B60W 30/09; B60W 30/0953; B60N 2/0276; B60W 2710/30; B60W 2550/10; B60W 2720/106; B60W 2520/10

(57) ABSTRACT

A Pre-Active Adjustment Safety control method includes: determining whether a possibility of collision exceeds a predetermined value based on sensing information received from at least one of a front sensor, a lateral sensor or a rear sensor; determining a position of a seat and an angle of a seat back when the possibility of collision exceeds the predetermined value; and controlling the seat to a predetermined state when at least one of the position of the seat or the angle of the seat back is not in the predetermined state.

### CROSS REFERENCE TO RELATED APPLICATION

This application claims priority under 35 U.S.C. § 119 to Korean Application No. 10-2018-0128775 filed in Korea on Oct. 26, 2018, which is hereby incorporated in its entirety by reference as if fully set forth herein.

### BACKGROUND

### Field of the Disclosure

Embodiments of the present disclosure relate to a Pre-Active Adjustment Safety control method and apparatus.

### Discussion of the Related Art

In general, a seat mounted or installed inside a vehicle has a seat cushion which is in contact with the hip of a driver or a passenger. The seat also has a seat back which is in contact with the back of the driver or passenger. The seat also includes a device for controlling the position of the seat and the seat back in consideration of the shape and posture or position of the body of the driver.

In a conventional seat control apparatus, the head and chest of a passenger may be mainly injured at the time of a collision. Although a seat belt and an airbag are mounted or installed in order to prevent the main body parts of the passenger from being injured, if a collision speed is high, if the position of a seat is rearward, or if the back of the seat is reclined, serious injuries may occur.

### SUMMARY OF THE DISCLOSURE

Accordingly, in this technology, it is possible to provide seat control technology for predicting a collision using front, lateral, and rear advanced driver-assistance system (ADAS) sensors and reducing injury of a passenger in an abnormal posture or position which is out of the safety range of a seat belt and an airbag.

Accordingly, embodiments are directed to a Pre-Active Adjustment Safety control method and system that substantially obviate one or more problems due to limitations and disadvantages of the related art.

In one embodiment, a Pre-Active Adjustment Safety control method includes determining whether a possibility of collision exceeds a predetermined value based on sensing information received from at least one of a front sensor, a lateral sensor, or a rear sensor. The control method further includes determining a position of a seat and an angle of a seat back when the possibility of collision exceeds the predetermined value. The control method also includes controlling the seat to a predetermined state when at least one of the position of the seat or the angle of the seat back is not in the predetermined state.

In some embodiments, the determining of whether the possibility of collision exceeds the predetermined value based on sensing information received from the front sensor may include: determining whether a speed of a vehicle is equal to or less than a predetermined speed; determining whether a distance from a front object is equal to or less than a predetermined distance when the speed of the vehicle is equal to or less than the predetermined speed; and determining whether the front object is approaching when the distance from the front object is equal to or less than the predetermined distance.

In some embodiments, the determining of whether the possibility of collision exceeds the predetermined value based on sensing information received from the lateral sensor may include: determining whether a lateral object is approaching the vehicle in a vertical direction; determining whether a distance between the lateral object and the vehicle is equal to or less than a predetermined distance when the lateral object is approaching the vehicle in the vertical direction; and determining whether a speed of the lateral object is equal to or greater than a predetermined speed when the distance from the lateral object is equal to or less than the predetermined distance.

In some embodiments, the determining of whether the possibility of collision exceeds the predetermined value based on sensing information received from the rear sensor may include: determining whether a distance from a rear object is equal to or less than a predetermined distance; and determining whether a speed of the rear object is equal to or greater than a predetermined speed when the distance from the rear object is equal to or less than the predetermined distance.

In some embodiments, the Pre-Active Adjustment Safety control method may further include performing collision warning when the possibility of collision exceeds the predetermined value and performing control to reduce the speed of the vehicle according to a predetermined step to perform collision avoidance operation, after performing the collision warning.

In some embodiments, the Pre-Active Adjustment Safety control method may further include determining whether collision occurs and returning to a posture before seat posture control when collision does not occur.

In some embodiments, the Pre-Active Adjustment Safety control method may further comprise evaluating a degree of safety of the vehicle according to seat posture control when collision occurs.

In some embodiments, the controlling of the seat to the predetermined state may include controlling the seat to move to a position separated from a foremost position of the seat by 150 mm (5.90 inch) or more.

In some embodiments, the controlling of the seat to the predetermined state may include controlling the seat back to rotate forward when the seat back is at the rear of a vertical direction of the seat back.

### BRIEF DESCRIPTION OF THE DRAWINGS

Arrangements and embodiments are described in detail with reference to the following drawings in which like reference numerals refer to like elements and wherein:

FIG. 1 is a block diagram showing a pre-safe control apparatus according to an embodiment of the present disclosure;

FIGS. 2(a)-2(c) are diagrams showing a seat posture based on frontal collision according to an embodiment of the present disclosure;

FIGS. 3(a) and 3(b) are diagrams showing a seat posture based on lateral collision according to an embodiment of the present disclosure;

FIGS. 4(a)-4(d) are diagrams showing a seat posture based on backward collision according to an embodiment of the present disclosure;

FIG. 5 is a flowchart illustrating a Pre-Active Adjustment Safety control method according to an embodiment of the present disclosure;

FIG. 6 is a flowchart illustrating a method of determining a possibility of frontal collision according to an embodiment of the present disclosure;

FIG. 7 is a flowchart illustrating a method of determining a possibility of lateral collision according to an embodiment of the present disclosure;

FIG. 8 is a flowchart illustrating a method of determining a possibility of backward collision according to an embodiment of the present disclosure;

FIG. 9 is a view showing FCA operation of a vehicle based on the determination of the possibility of frontal collision according to an embodiment of the present disclosure;

FIG. 10 is a view showing FCA operation of a vehicle based on the determination of the possibility of lateral and backward collision according to an embodiment of the present disclosure; and

FIGS. 11(a) and 11(b) are contour plots of the position of a seat and the angle of a seat back based on a new car assessment program (NCAP) test according to an embodiment of the present disclosure.

### DETAILED DESCRIPTION OF THE DISCLOSURE

An apparatus and various methods, to which the embodiments of the present disclosure are applied, are described more fully hereinafter with reference to the accompanying drawings. The suffixes “module” and “unit” of elements herein are used for convenience of description and thus can be used interchangeably and do not have any distinguishable meanings or functions.

In the following description of the embodiments, it will be understood that, when each element is referred to as being formed “on” (above) or “under” (below) or “before” (ahead) or “after” (behind) the other element, it can be directly “on” (above) or “under” (below) or “before” (ahead) or “after” (behind) the other element or be indirectly formed with one or more intervening elements therebetween.

It will be understood that, although the terms first, second, A, B, (a), (b), etc. may be used herein to describe various elements of the present disclosure, these terms are only used to distinguish one element from another element and necessity, order, or sequence of corresponding elements are not limited by these terms. It will be understood that when one element is referred to as being “connected to”, “coupled to”, or “accessing” another element, one element may be “connected to”, “coupled to”, or “accessing” another element via a further element although one element may be directly connected to or directly access another element.

The term “comprises”, “includes”, or “has” described herein should be interpreted not to exclude other elements but to further include such other elements since the corresponding elements may be inherent unless mentioned otherwise. All terms including technical or scientific terms have the same meanings as generally understood by a person having ordinary skill in the art to which the present disclosure pertains unless mentioned otherwise. Generally used terms, such as terms defined in a dictionary, should be interpreted to coincide with meanings of the related art from the context. Unless obviously defined in the present disclosure, such terms are not interpreted as having ideal or excessively formal meanings.

The Pre-Active Adjustment Safety control method and apparatus according to the present disclosure can determine a possibility of collision through advanced driver-assistance system (ADAS) sensors and a seat posture controller. The control method can further secure a seat control time through reduced speed control. The control method can also control the posture of a seat to a predetermined posture through control of the position of the seat and the angle of the back of the seat.

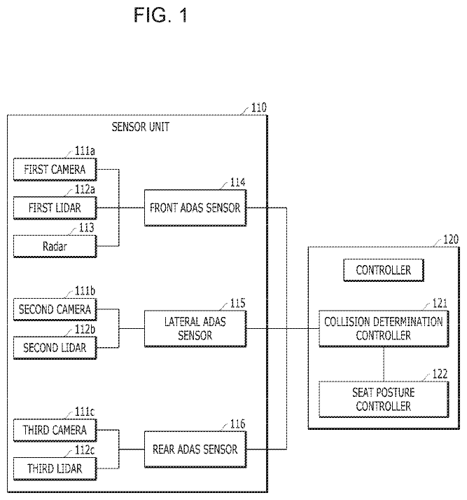

FIG. 1 is a block diagram showing a pre-safe control apparatus according to an embodiment of the present disclosure.

Referring to FIG. 1, the pre-safe control apparatus may include a sensor unit 110 and a controller 120.

The sensor unit 110 may include sensors for sensing signals related to driving of a vehicle.

The sensor unit 110 may include a camera and may include a plurality of cameras 111a, 111b and 111c. The first camera 111a may be disposed at the front of the vehicle, the second camera 111b may be disposed at the lateral side of the vehicle, and the third camera 111c may be disposed at the rear of the vehicle.

The first camera 111a may acquire and transmit the front image of the vehicle to a front advanced driver assistance system (ADAS) sensor 114. The second camera 111b may acquire and transmit the lateral image of the vehicle to a lateral ADAS sensor 115. The third camera 111c may acquire and transmit the rear image of the vehicle to a rear ADAS sensor 116.

The sensor unit 110 may include a light detection and ranging (lidar). A first lidar 112a may be disposed at the front of the vehicle, a second lidar 112b may be disposed at the lateral side of the vehicle, and a third lidar 112c may be disposed at the rear of the vehicle.

The first lidar 112a may acquire and transmit the position information of a front object of the vehicle to the front ADAS sensor 114. The second lidar 112b may acquire and transmit the position information of a lateral object of the vehicle to the lateral ADAS sensor 115. The third lidar 112c may acquire and transmit the position information of a rear object of the vehicle to the rear ADAS sensor 116.

The sensor unit 110 may include a radar. The radar may be disposed at the front of the vehicle. The radar may acquire and transmit the position information of the front object of the vehicle to the front ADAS sensor 114.

The sensor unit 110 may include the front ADAS sensor 114, the lateral ADAS sensor 115 and the rear ADAS sensor 116.

The front ADAS sensor 114 may calculate a distance from an approaching frontal-collision object and a relative speed and an acceleration based on information received from the first camera, the first lidar 112a and the radar.

The lateral ADAS sensor 115 may calculate a distance from an approaching lateral-collision object. The lateral ADAS sensor 115 may further calculate a relative speed and an acceleration based on information received from the second camera, the second lidar 112b and the radar.

The rear ADAS sensor 116 may calculate a distance from an approaching backward-collision object. The rear ADAS sensor 116 may also calculate a relative speed and an acceleration based on information received from the third camera, the third lidar 112c and the radar.

The controller 120 may include a collision determination controller 121 and a seat posture controller 122.

The collision determination controller 121 may receive a distance from a collision object approaching the vehicle. The collision determination controller 121 may also receive a relative speed and acceleration information from the front ADAS sensor 114, the lateral ADAS sensor 115, and the rear ADAS sensor 116.

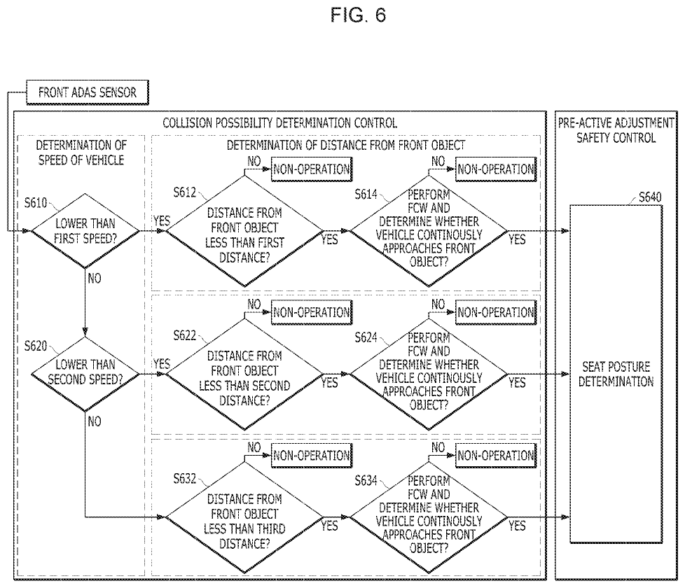

The collision determination controller 121 may determine a possibility of collision with the frontal-collision object based on the distance from the collision object, the relative speed and the acceleration information received from the front ADAS sensor 114. The collision determination controller 121 may perform control to sequentially perform frontal collision warning (FCW), frontal collision-avoidance assist (FCA) and evasive steering assist (ESA) when the possibility of collision with the frontal-collision object is higher than a predetermined value. At this time, when FCA is performed, the speed of the vehicle may be reduced. Therefore, it is possible to secure a time when the pre-safe control apparatus operates. The method of determining the possibility of collision at the collision determination controller 121 is described in detail below with reference to FIG. 6. Thereafter, the collision determination controller 121 may transmit a signal corresponding to the FCW to the seat posture controller 122.

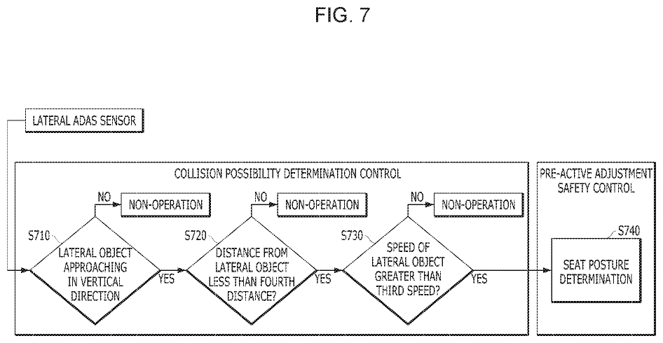

The collision determination controller 121 may determine a possibility of collision with the lateral-collision object based on the distance from the collision object, the relative speed and the acceleration information received from the lateral ADAS sensor 115. When the possibility of collision with the lateral-collision object is higher than a predetermined value through the lateral ADAS sensor 115, the controller may perform control to sequentially perform lateral collision warning (LCW) and lateral collision-avoidance assist (LCA). The method of determining the possibility of collision at the collision determination controller 121 is described in detail below with reference to FIG. 7. Thereafter, the collision determination controller 121 may transmit a signal corresponding to the LCW to the seat posture controller 122.

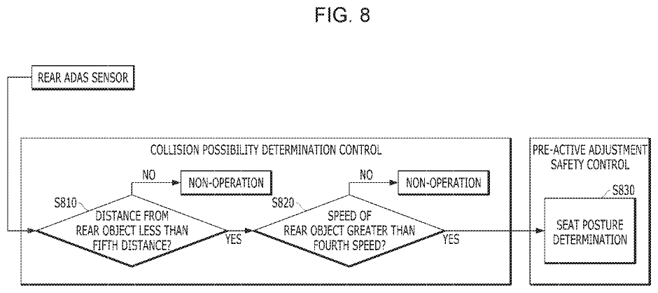

The collision determination controller 121 may determine a possibility of collision with the backward-collision object based on the distance from the collision object, the relative speed and the acceleration information received from the rear ADAS sensor 116. When the possibility of collision with the backward-collision object is higher than a predetermined value through the rear ADAS sensor 116, the controller 120 may perform control to sequentially perform backward collision warning (BCW) and backward collision-avoidance assist (BCA). The method of determining the possibility of backward collision at the collision determination controller 121 is described in detail below with reference to FIG. 8. Thereafter, the collision determination controller 121 may transmit a signal corresponding to the BCW to the seat posture controller 122.

After seat posture control, the collision determination controller 121 may determine whether collision occurs based on the acceleration of the vehicle. When collision does not occur, the collision determination controller 121 may transmit a posture return signal to the seat posture controller 122 to return to a posture before seat posture control.

The seat posture controller 122 may receive a warning signal including the FCW, LCW and BCW signals from the collision determination controller 121. When the seat posture controller 122 receives the warning signal, the seat posture controller 122 may determine the seat posture of the vehicle. The seat posture may include the position information of the seat 221 and the angle information of the seat back 222.

Thereafter, the seat posture controller 122 may control the seat posture in correspondence with the warning signal.

When the seat posture controller 122 receives the FCW signal, it is possible to control the seat posture to be close to the safety range of a seat belt and an airbag after checking the seat posture, before collision with the frontal-collision object.

When the seat posture controller 122 receives the LCW signal, it is possible to control the seat posture to prevent contact between a B-pillar and the head and upper body of a user after checking the seat posture, before collision with the lateral-collision object.

When the seat posture controller 122 receives the BCW signal, it is possible to control the seat posture to reduce a clearance between the user's body and the seat back 222 or a headrest after checking the seat posture, before collision with the backward-collision object. The seat posture controller 122 may perform control to move the seat to a position separated from a foremost position by 150 mm (5.90 inch) or more. For example, the range of the position of the seat 221 may be from 150-250 mm (5.90-9.84 inch).

The seat posture controller 122 may control the seat back to rotate forward when the seat back is at the rear of a vertical direction of the seat back. At this time, when the seat back 222 vertically stands, the angle of the seat back is 0 degrees and increases when the seat back rotates backward. For example, the seat posture controller 122 may perform control such that the seat back 222 is positioned in a range of 0 to 30 degrees.

The seat posture controller 122 may control the seat posture to return to the posture before seat posture control, when the posture return signal is received from the collision determination controller 121.

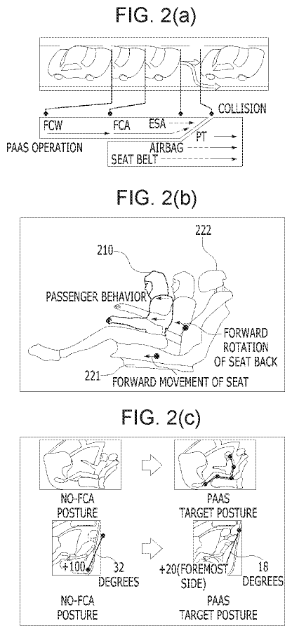

FIGS. 2(a)-2(c) are diagrams showing a seat posture based on frontal collision according to an embodiment of the present disclosure.

The vehicle may sequentially perform FCW, FCA and ESA operation when frontal collision is predicted.

Referring to FIG. 2(a), when FCW is performed based on the front ADAS, the Pre-Active Adjustment Safety (PAAS) control apparatus operates. While FCA and ESA are performed, the seat posture may be controlled through a power train (PT) and the seat belt and the airbag may operate.

Referring to FIG. 2(b), the seat posture is being controlled to be close to the safety range of the seat belt and the airbag after checking the posture of a passenger 210 before collision. At this time, the position of the seat 221 may move forward and the seat back 222 may stand through forward rotation.

FIG. 2(c) shows a seat posture in a NO-FCA state and a seat posture according to the PAAS according to an embodiment of the present disclosure. In the NO-FCA state, the position of the seat 221 may be moved from the foremost side of the seat by 100 mm (3.937 inch) and the angle of the seat back 222 may be 32 degrees.

Thereafter, the Pre-Active Adjustment Safety control apparatus may operate, such that the position of the seat 221 may be moved to a position 20 mm (0.787 inch) from the foremost side of the seat and the angle of the seat back 222 may be changed to 18 degrees.

The seat may be located at the foremost side of the seat according to posture control of the Pre-Active Adjustment Safety, thereby reducing injury.

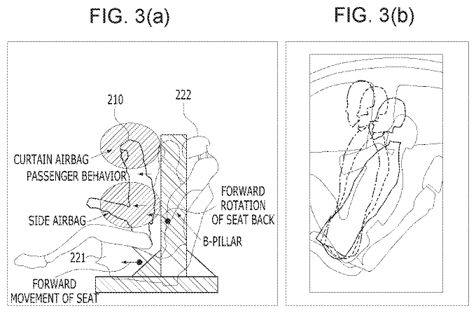

FIGS. 3(a) and 3(b) are diagrams showing a seat posture based on lateral collision according to an embodiment of the present disclosure

Referring to FIGS. 3(a) and 3(b), the seat posture may be controlled to prevent contact between a B-pillar and the head and upper body of the passenger 210 after checking the seat posture before lateral collision.

At this time, in order to reduce injury caused by lateral collision, a curtain airbag may operate to control a posture for protecting the head of the passenger 210.

In addition, in order to reduce injury caused by lateral collision, a side airbag may operate to control a posture for protecting the body of the passenger 210.

To this end, the position of the seat 221 may move forward and the seat back 222 may stand, i.e., move to a more upright orientation, through forward rotation. The seat posture may be controlled through the power train (PT).

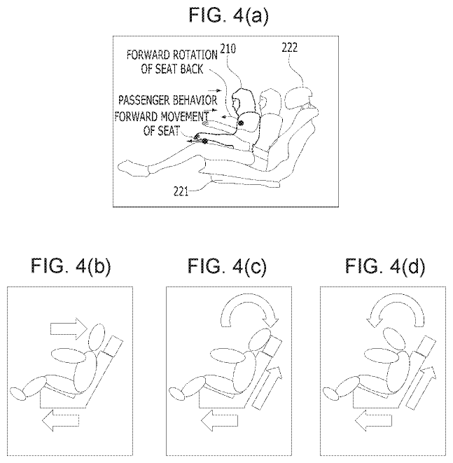

FIGS. 4(a)-4(d) are diagrams showing a seat posture based on backward collision according to an embodiment of the present disclosure.

Referring to FIG. 4(a), the seat posture is being controlled to be close to the safety range of the seat belt and the airbag after checking the posture of a passenger before backward collision. At this time, the position of the seat 221 may move forward and the seat back 222 may stand through forward rotation.

Referring to FIGS. 4(b)-4(d), acceleration of the head may occur at the backward collision.

Thereafter, as the clearance between the head of the passenger 210 and the seat back 222 or the headrest increases, the amount of movement of the body of the passenger and the amount of backward movement of the head of the passenger increase.

Thereafter, the amount of forward movement of the head of the passenger 210 increases due to rebound after the head of the passenger 210 comes into contact with the seat back 222 or the headrest. Therefore, the head and neck of the passenger 210 may be injured.

In order to prevent this, the upper body of the passenger 210 and the seat back 222 may be controlled to be in close contact with each other in order to secure performance of the headrest mounted to reduce injury at the time of backward collision.

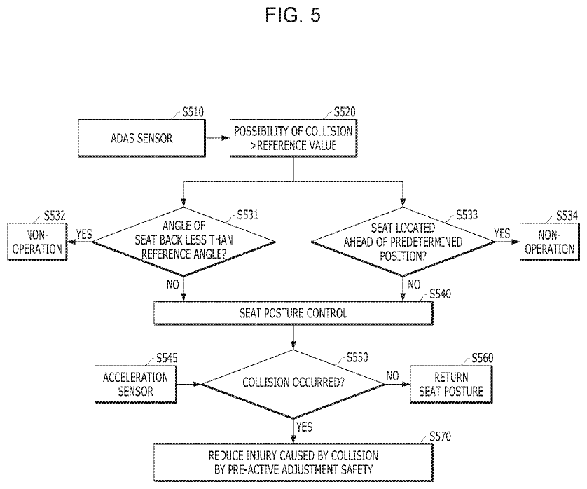

FIG. 5 is a flowchart illustrating a Pre-Active Adjustment Safety control method according to an embodiment of the present disclosure.

Referring to FIG. 5, the controller 120 may receive the distance from the collision object, the relative speed and the acceleration information from the ADAS sensor and determine whether the possibility of collision with the collision object exceeds the predetermined value (S510 and S520).

When the possibility of collision exceeds the predetermined value, the controller 120 may determine the posture of the seat. The controller 120 may determine whether the angle of the seat back 222 is less than a reference angle (S531). After step S531, when the angle of the seat back 222 is less than the reference angle, Pre-Active Adjustment Safety control may not be performed (S532).

After step S520, whether the seat 221 is located ahead of a predetermined position may be determined (S533). After step S533, when the seat 221 is located ahead of the predetermined position, seat control may not be performed (S534).

After at least one of steps S531 and S533, the controller 120 may control the seat posture. Therefore, the controller 120 may perform control of the seat to move forward during a predetermined time before collision and control the angle of the seat back 222 such that the seat back stands upright (S540).

After step S540, the controller 120 may determine whether collision of the vehicle occurs based on the acceleration information from an acceleration sensor (S545 and S550).

After step S550, upon determining that collision does not occur, the controller 120 may perform control to return to the posture before seat posture control (S560).

After step S550, upon determining that collision occurs, injury caused by collision may be reduced by Pre-Active Adjustment Safety (S570).

FIG. 6 is a flowchart illustrating a method of determining a possibility of frontal collision according to an embodiment of the present disclosure.

Referring to FIG. 6, the controller 120 may receive the distance from the frontal-collision object, the relative speed and the acceleration information from the front ADAS sensor 114. Thereafter, the controller 120 may determine the speed of the vehicle. The controller 120 may determine whether the speed of the vehicle is lower than a first speed of the vehicle (S610).

When the speed of the vehicle is lower than the first speed, the controller 120 may determine whether a distance from the front object is less than a first distance (S612). If step S612 is not satisfied, seat control may not be performed.

When the distance from the front object is less than the first distance, the controller 120 may perform control to perform FCW and determine whether the vehicle continuously approaches the front object (S614). Upon determining that the vehicle continuously approaches the front object, the controller 120 may transmit a frontal-collision signal of the vehicle. If step S614 is not satisfied, seat control may not be performed.

After step S614, when the vehicle does not continuously approach the front object, seat control may not be performed.

After step S610, when the speed of the vehicle is equal to or greater than the first speed, the controller 120 may determine whether the speed of the vehicle is less than a second speed (S620).

When the speed of the vehicle is less than the second speed, the controller 120 may determine whether the distance from the front object is less than a second distance (S622). If step S622 is not satisfied, seat control may not be performed.

When the distance from the front object is less than the second distance, the controller 120 may perform control to perform FCW and determine whether the vehicle continuously approaches the front object (S624). Upon determining that the vehicle continuously approaches the front object, the controller 120 may transmit a frontal-collision signal of the vehicle. If step S624 is not satisfied, seat control may not be performed.

When the speed of the vehicle is equal to or greater than the second speed, the controller 120 may determine whether the distance from the front object is less than a third distance (S632). If step S632 is not satisfied, seat control may not be performed.

When the distance from the front object is less than the third distance, the controller 120 may perform control to perform FCW and determine whether the vehicle continuously approaches the front object (S634). Upon determining that the vehicle continuously approaches the front object, the controller 120 may transmit a frontal-collision signal of the vehicle. If step S634 is not satisfied, seat control may not be performed.

When the frontal-collision signal is received by at least one of steps S614, S624 and S634, it may be determined that there is a possibility of frontal-collision of the vehicle and the posture of the seat for Pre-Active Adjustment Safety control may be determined (S640).

FIG. 7 is a flowchart illustrating a method of determining a possibility of lateral collision according to an embodiment of the present disclosure.

Referring to FIG. 7, the controller 120 may receive the distance from the lateral-collision object and the relative speed and the acceleration information from the lateral ADAS sensor 115. Thereafter, the controller 120 may determine whether the lateral object is approaching in a vertical direction (S710). If step S710 is not satisfied, seat control may not be performed.

After step S710, when the lateral object is approaching in the vertical direction, the controller 120 may determine whether the distance between the lateral object and the vehicle is less than a fourth distance (S720). If step S720 is not satisfied, seat control may not be performed.

After step S720, when the distance between the lateral object and the vehicle is less than the fourth distance, the controller 120 may determine whether the speed of the lateral object is greater than a third speed. Upon determining that the speed of the lateral object is greater than the third speed, the controller 120 may transmit a lateral-collision signal (S730). If step S730 is not satisfied, seat control may not be performed.

After step S730, when the lateral-collision signal is received, the controller 120 may determine that there is a possibility of lateral-collision of the vehicle and determine the posture of the seat for Pre-Active Adjustment Safety control (S740).

FIG. 8 is a flowchart illustrating a method of determining a possibility of backward collision according to an embodiment of the present disclosure.

Referring to FIG. 8, the controller 120 may receive the distance from the backward-collision object, the relative speed and the acceleration information from the rear ADAS sensor 116. Thereafter, the controller 120 may determine whether a distance between the rear object and the vehicle is less than a fifth distance (S810). If step S810 is not satisfied, seat control may not be performed.

After step S810, when the distance between the rear object and the vehicle is less than the fifth distance, the controller 120 may determine whether the speed of the rear object is greater than a fourth speed. Upon determining that the speed of the rear object is greater than the fourth speed, the controller 120 may transmit a backward-collision signal (S820). If step S820 is not satisfied, seat control may not be performed.

After step S820, when the backward-collision signal is received, the controller 120 may determine that there is a possibility of backward-collision of the vehicle and determine the posture of the seat for Pre-Active Adjustment Safety control (S830).

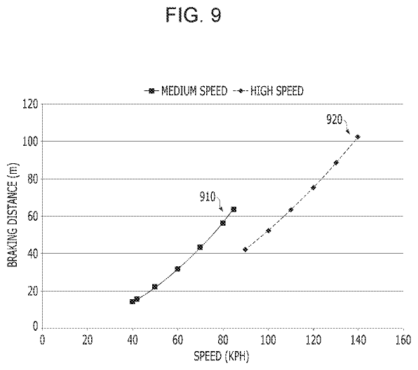

FIG. 9 is a view showing FCA operation of a vehicle based on the determination of the possibility of frontal collision according to an embodiment of the present disclosure.

The horizontal axis of the graph shown in FIG. 9 represents the speed of the vehicle and the vertical axis of the graph represents a braking distance. The graph shows the braking distance according to FCA when the speed of the vehicle is medium (910) and a braking distance according to FCA when the speed of the vehicle is high (920).

Referring to FIG. 9, in the case of frontal collision, the speed of the vehicle may be controlled to be reduced in three steps by FCA. Therefore, a passenger in an abnormal posture may be moved to a normal posture optimized for performance of the seat belt and the airbag by PAAS operation during a period in time secured before collision.

In other words, the controller 120 may determine the possibility of collision of the vehicle after FCA operation.

For example, the controller 120 may secure a Pre-Active Adjustment Safety operation time of about 2.3 seconds through FCA before collision, when the initial speed of the vehicle is greater than 42 kph (26.09 mph) and is equal to or less than 85 kph (52.82 mph). In other words, when a stationary object is present 64 m (209.97 ft) ahead of the vehicle, a collision speed may be controlled to 60 kph (37.28 mph) or less through deceleration using FCA. To this end, deceleration of the vehicle may be controlled to 0.2 g (1.2 s)/0.35 g (0.7 s)/0.8 g (0.3 s) after FCW. Accordingly, when FCA is performed and the front object moves at a speed of 60 kph, it may be determined that the possibility of collision is low.

For example, if the initial speed is 42 kph or less, the controller 120 may secure the Pre-Active Adjustment Safety operation time of about 2.3 seconds through FCA before collision. In other words, a stationary object is present 16 m (52.49 ft) ahead of the vehicle, a collision speed may be controlled to 30 kph (18.64 mph) or less through deceleration using FCA. To this end, the deceleration of the vehicle may be controlled to 0.2 g (0.6 s)/0.35 g (0.3 s)/0.8 g (0.2 s) after FCW. Accordingly, when FCA is performed and the front object moves at a speed of 30 kph, it may be determined that the possibility of collision is low.

For example, when the initial speed of the vehicle is greater than 82 kph (50.05 mph) and less than 170 kph (105.63 mph), the vehicle may be decelerated through FCA such that the speed of the vehicle may be maximally reduced at the time of collision of the stationary object located ahead. To this end, the deceleration of the vehicle may be controlled to 0.4 g (0.6˜1.2 s)/0.8 g (0.3˜0.6 s)/1.0 g (0.3˜0.5 s).

Each of initial speed, the Pre-Active Adjustment Safety operation time and the distance from the collision object are examples, and the present disclosure is not limited thereto.

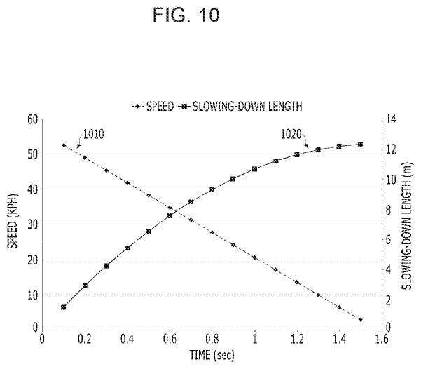

FIG. 10 is a view showing FCA operation of a vehicle based on the determination of the possibility of lateral and backward collision according to an embodiment of the present disclosure.

The horizontal axis of the graph shown in FIG. 10 represents a PAAS operable time, a left vertical axis of the graph represents the speed of the vehicle, and the right vertical axis of the graph represents a slowing-down length. The graph shows change in speed 1010 according to time and change in slowing-down length 1020 according to time.

Referring to FIG. 10, in the case of lateral and backward collision, a vehicle approaching during driving may be identified, an object within a predetermined distance may be recognized, and the PAAS operable time may be calculated by measuring positional change of the object relative to distance. Accordingly, the controller 120 may perform free-safe seat control for a partial time after LCW and BCW.

For example, when the initial relative speed of the vehicle is 56 kph (34.79 mph) or less and the object is decelerated at acceleration of 9.8 m/s\hat{ }2 (32.15 ft/s\hat{ }2) at the time of collision with the object located 12 m (39.37 ft) from the vehicle, the relative speed becomes 15 kph (9.32 mph) or less and the possibility of collision may be determined.

For example, when the initial relative speed of the vehicle is greater than 56 kph and equal to or less than 82 kph (50.95 mph) and the object is decelerated at 9.8 m/s\hat{ }2 at the time of collision with the object located 12 m from the vehicle, the relative speed maximally becomes 61 kph (37.90 mph)or less and the possibility of collision may be determined.

Each of initial speed, the Pre-Active Adjustment Safety operation time and the distance from the collision object are examples. The present disclosure is not limited thereto.

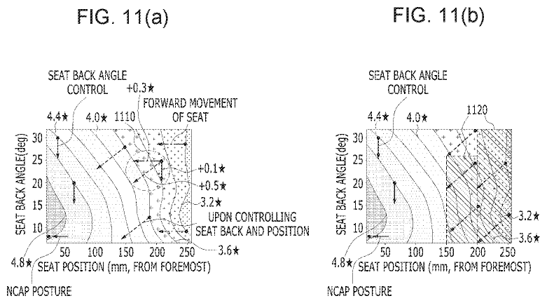

FIGS. 11(a) and 11(b) are contour plots of the position of a seat and the angle of the seat back according to a new car assessment program (NCAP) test according to an embodiment of the present disclosure.

The horizontal axis of the graphs shown in FIGS. 11(a) and 11(b) represent the position of the seat and the vertical axis of the graph represents the angle of the seat back 222.

NCAP refers to a test to evaluate crashworthiness of a vehicle. The degree of injury of a passenger when the vehicle frontally collides with a wall may be divided into 1-star to 5-star ratings.

When the position of the seat 221 is controlled through Pre-Active Adjustment Safety control, the star rating may be improved by 0.2 to 0.5 stars. When the angle of the seat back 222 is controlled through Pre-Active Adjustment Safety control, the star rating may be improved by 0.2 stars.

Accordingly, when the position of the seat 221 and the angle of the seat back 222 are controlled through Pre-Active Adjustment Safety control, the star rating may be maximally improved by 0.8 stars.

Referring to FIG. 11(a), in a region 1110, the star rating may be improved by 0.3 stars through Pre-Active Adjustment Safety control when the position of the seat 221 is moved forward, may be improved by 0.1 stars when the angle of the seat back 222 is controlled, and may be improved by 0.5 stars when the angle of the seat back 222 and the position of the seat 221 are controlled.

Referring to FIG. 11(b), in a region 1120, when the angle of the seat back 222 and the position of the seat 221 are controlled, the position of the seat 221 may be controlled to be in a range of 150 (5.90 inch)-250 mm (9.84 inch). At this time, the angle of the seat back 222 may be in a range of 0 to 30 degrees.

The Pre-Active Adjustment Safety control method and system according to the present disclosure have the following effects.

First, it is possible to reduce injury of a passenger who is out of an effective safety range of a seat belt and an airbag, i.e., a passenger who is improperly restrained or positioned, at the time of frontal collision.

Second, since it is possible to return the seat to an original posture when collision does not occur and to avoid a collision even if a possibility of collision is equal to or less than a reference value, it is possible to enable a passenger to confirm or achieve the safety of a vehicle.

The method according to an embodiment of the present disclosure may be implemented as a program, i.e. computer-executable code, for execution on a computer and stored in a computer-readable recording medium. A controller and/or hardware processor coupled to the computer-readable recording medium may be configured to execute the computer-executable code. Examples of the computer-readable recording medium include a ROM, a RAM, a CD-ROM, a magnetic tape, a floppy disk, and an optical data storage. The computer-readable recording medium can be distributed over a plurality of computer devices connected to a network so that computer-readable code is written thereto and executed therefrom in a decentralized manner. Functional programs, code, and code segments needed to realize the embodiments herein can be construed by one of ordinary skill in the art.

What is claimed is:

1. A Pre-Active Adjustment Safety control method comprising:
determining whether a possibility of collision exceeds a predetermined value based on sensing information received from at least one of a front sensor, a lateral sensor or a rear sensor;
determining a position of a seat and an angle of a seat back when the possibility of collision exceeds the predetermined value; and
controlling the seat to a predetermined state when at least one of the position of the seat or the angle of the seat back is not in the predetermined state.

2. The Pre-Active Adjustment Safety control method according to claim 1, wherein the determining of whether the possibility of collision exceeds the predetermined value based on sensing information received from the front sensor includes:
determining whether a speed of a vehicle is equal to or less than a predetermined speed;
determining whether a distance from a front object is equal to or less than a predetermined distance when the speed of the vehicle is equal to or less than the predetermined speed; and
determining whether the front object is approaching when the distance from the front object is equal to or less than the predetermined distance.

3. The Pre-Active Adjustment Safety control method according to claim 1, wherein the determining of whether the possibility of collision exceeds the predetermined value based on sensing information received from the lateral sensor includes:
determining whether a lateral object is approaching the vehicle in a vertical direction;
determining whether a distance between the lateral object and the vehicle is equal to or less than a predetermined distance when the lateral object is approaching the vehicle in the vertical direction; and
determining whether a speed of the lateral object is equal to or greater than a predetermined speed when the distance from the lateral object is equal to or less than the predetermined distance.

4. The Pre-Active Adjustment Safety control method according to claim 1, wherein the determining of whether the possibility of collision exceeds the predetermined value based on sensing information received from the rear sensor includes:
determining whether a distance from a rear object is equal to or less than a predetermined distance; and
determining whether a speed of the rear object is equal to or greater than a predetermined speed when the distance from the rear object is equal to or less than the predetermined distance.

5. The Pre-Active Adjustment Safety control method according to claim 1, further comprising:
performing collision warning when the possibility of collision exceeds the predetermined value; and
performing control to reduce the speed of the vehicle according to a predetermined step to perform collision avoidance operation, after performing the collision warning.

6. The Pre-Active Adjustment Safety control method according to claim 1, further comprising:
determining whether collision occurs; and
returning to a posture before seat posture control when collision does not occur.

7. The Pre-Active Adjustment Safety control method according to claim 6, further comprising evaluating a degree of safety of the vehicle according to seat posture control when collision occurs.

8. The Pre-Active Adjustment Safety control method according to claim 1, wherein the controlling of the seat to the predetermined state includes controlling the seat to move to a position separated from a foremost position of the seat by 150 mm or more.

9. The Pre-Active Adjustment Safety control method according to claim 1, wherein the controlling of the seat to the predetermined state includes controlling the seat back to rotate forward when the seat back is at the rear of a vertical direction of the seat back.

10. A computer-readable recording medium coupled to a controller, the computer-readable recording medium having recorded thereon computer-executable code for realizing, by the controller, the Pre-Active Adjustment Safety control method according to claim 1.

11. A Pre-Active Adjustment Safety control apparatus comprising:
a sensor unit including a front sensor, a lateral sensor and a rear sensor; and
a controller including a collision determination controller and a seat posture controller,
wherein the collision determination controller determines whether a possibility of collision exceeds a predetermined value based on sensing information received from at least one of the front sensor, the lateral sensor or the rear sensor, and
wherein the posture controller:
determines a position of a seat and an angle of a seat back when the possibility of collision exceeds the predetermined value; and
controls the seat to a predetermined state when at least one of the position of the seat or the angle of the seat back is not in the predetermined state.

12. The Pre-Active Adjustment Safety control apparatus according to claim 11, wherein the collision determination controller:
determines whether a speed of a vehicle is equal to or less than a predetermined speed when the sensing information is received from the front sensor;
determines whether a distance from a front object is equal to or less than a predetermined distance when the speed of the vehicle is equal to or less than the predetermined speed; and
determines whether the front object is approaching when the distance from the front object is equal to or less than the predetermined distance.

13. The Pre-Active Adjustment Safety control apparatus according to claim 11, wherein the collision determination controller:
determines whether a lateral object is approaching the vehicle in a vertical direction when the sensing information is received from the lateral sensor;
determines whether a distance between the lateral object and the vehicle is equal to or less than a predetermined distance when the lateral object is approaching the vehicle in the vertical direction; and
determines whether a speed of the lateral object is equal to or greater than a predetermined speed when the distance from the lateral object is equal to or less than the predetermined distance.

14. The Pre-Active Adjustment Safety control apparatus according to claim 11, wherein the collision determination controller:
determines whether a distance from a rear object is equal to or less than a predetermined distance when the sensing information is received from the rear sensor; and
determines whether a speed of the rear object is equal to or greater than a predetermined speed when the distance from the rear object is equal to or less than the predetermined distance.

15. The Pre-Active Adjustment Safety control apparatus according to claim 11, wherein the collision determination controller performs control to:
perform collision warning when the possibility of collision exceeds the predetermined value; and
reduce the speed of the vehicle according to a predetermined step to perform collision avoidance operation, after performing the collision warning.

16. The Pre-Active Adjustment Safety control apparatus according to claim 11, wherein the collision determination controller determines whether collision occurs and perform control to return to a posture before seat posture control when collision does not occur.

17. The Pre-Active Adjustment Safety control apparatus according to claim 16, wherein the seat posture controller evaluates a degree of safety of the vehicle according to seat posture control when collision occurs.

18. The Pre-Active Adjustment Safety control apparatus according to claim 11, wherein the seat posture controller controls the seat to move to a position separated from a foremost position of the seat by 150 mm or more.

19. The Pre-Active Adjustment Safety control apparatus according to claim 11, wherein the seat posture controller controls the seat back to rotate forward when the seat back is at the rear of a vertical direction of the seat back.

20. A Pre-Active Adjustment Safety control apparatus comprising:
a sensor unit including a front sensor, a lateral sensor and a rear sensor;
a processor; and
a computer-readable medium including computer-executable code that, when executed by the processor, cause the Pre-Active Adjustment Safety control apparatus to
determine whether a possibility of collision exceeds a predetermined value based on sensing information received from at least one of the front sensor, the lateral sensor or the rear sensor,
determine a position of a seat and an angle of a seat back when the possibility of collision exceeds the predetermined value, and
control the seat to a predetermined state when at least one of the position of the seat or the angle of the seat back is not in the predetermined state.
